(19) United States
(12) Patent Application Publication
(10) Pub. No.: US 2013/0228976 A1
(43) Pub. Date: Sep. 5, 2013

(54) M Thermodynamic resonant engine with a rotary variant

(71) Applicant: Ion Murgu, (US)

(72) Inventor: Ion Murgu, (US)

(21) Appl. No.: 13/412,592

(22) Filed: Mar. 5, 2012

(51) Int. Cl. F02B 37/00; F16J 15/16; F02B 75/00

(52) U.S. Cl. 277/345; 60/605.1

(57) ABSTRACT

A 3-D geometric separation of old engine compression-ignition-expansion chamber in compression-ignition chamber and expansion chamber with a parametric delay between ignition and expansion ( and excluding the intake valves and exhaust valves) what to permit a symmetric configuration for a totally rotary engine and a special arrangements(as is revealed in drawings and explained in description) of mechanical and electrical components acting resonant with thermodynamic processes against of internal and external absorption's processes using maximal the caloric energy of a combustible and creating a cyclic thermodynamic parametric resonant loop, process maintained from increasing or decreasing the dynamic pressure and thermo gradient and mechanically mirrored in a increasing or decreasing engine RPM or it's new parameter, the ignition timing delay.

### CROSS-REFERENCE TO RELATED ART

This application is a variant finalized form of Romanian application: Application Nr. 96-01362 MOTOR TERMIC REZONANT OSIM, Romania

### STATEMENT REGARDING FEDERALLY SPONSORED RESEARCH OR DEVELOPMENT

Not Applicable

### FIELD OF THE INVENTION

The present invention relates to the field of internal combustion engines and more particularly to a Wankel rotary type engines but without eccentric rotor component(a totally rotary engine).

This application prove a geometric configuration what can to define a absolute rotary engine and future experimental work will improve it's configuration and form with the best numbers of expansion chambers on rotor and the best dimensions of components for what kind of power or RPM needed. If technologically this engine will can be build is possibly to be the best pulse turbine and then the best air supplier for a jet engine too, because after reaching it's regime of work this engine no longer will need it's overpressure pistons and those can be blocked in closed position or accepting a hard start without pistons at all(excluding it's diesel variant what will need overpressure pistons working all the time).

### BACKGROUND OF THE INVENTION

This engine was ready in a primitive form between 1988-1995, but because didn't meet under stability and because, ever now, I don't know yet if we can build technologically this engine I am back with it's finalized proposal. To be functional, this engine must to have is cylindrical interior of stator and cylindrical exterior of rotor near of perfect, the shaft must to be perfectly centered and technologically to can do the M-seal. For M-seal are any adjacent solutions. This engine was a high school child obsession that a perfect rotary engine must to have a solution and solution can be to separate geometrically the old cylinder chamber in two, a compression-ignition chamber and a expansion chamber. The delay between explosion and detention will be infinitesimally at the regime work engine and can be used parametric. To eliminate the confusion between compression-ignition chamber split on stator and rotor and a separation all chamber in two, compression-ignition chamber and expansion chambers what is the space back of every pallet and is formed from delimitation between back pallet wall, R-reflector and after shock balances. Anyway in a embodiment of this engine all compression-ignition chamber can to be only on stator but in other embodiments the R-chamber split can to play a role of “magic cup”. Because the revolving force in R-chamber split (for any form) is 0 or a little bit positively the R-chambers isn't so important in rotor revolving but can be important in reading fuel for next explosion when the fuel is fluid not gas. I hope in viability of this engine because can to be the single engine what to no pollute the water and the best turbine air supplier for a jet engine.

### BRIEF DESCRIPTION OF THE DRAWINGS

FIG. 1 is a schematic front view of TRE engine only with a emblematic character to represent a totally rotary engine.

FIG. 2 is a schematic front up inclined view of TRE engine with any components moved to right.

FIG. 2A. is view of a molded TRE-engine without intake manifold, exhaust manifold and cam system.

FIG. 2B. is view of a molded TRE-engine without intake manifold, exhaust manifold and cam system in inclined position.

FIG. 3 is view of a molded TRE-rotor from laterally inclined.

FIG. 4 is a schematic drawings view of TRE-rotor.

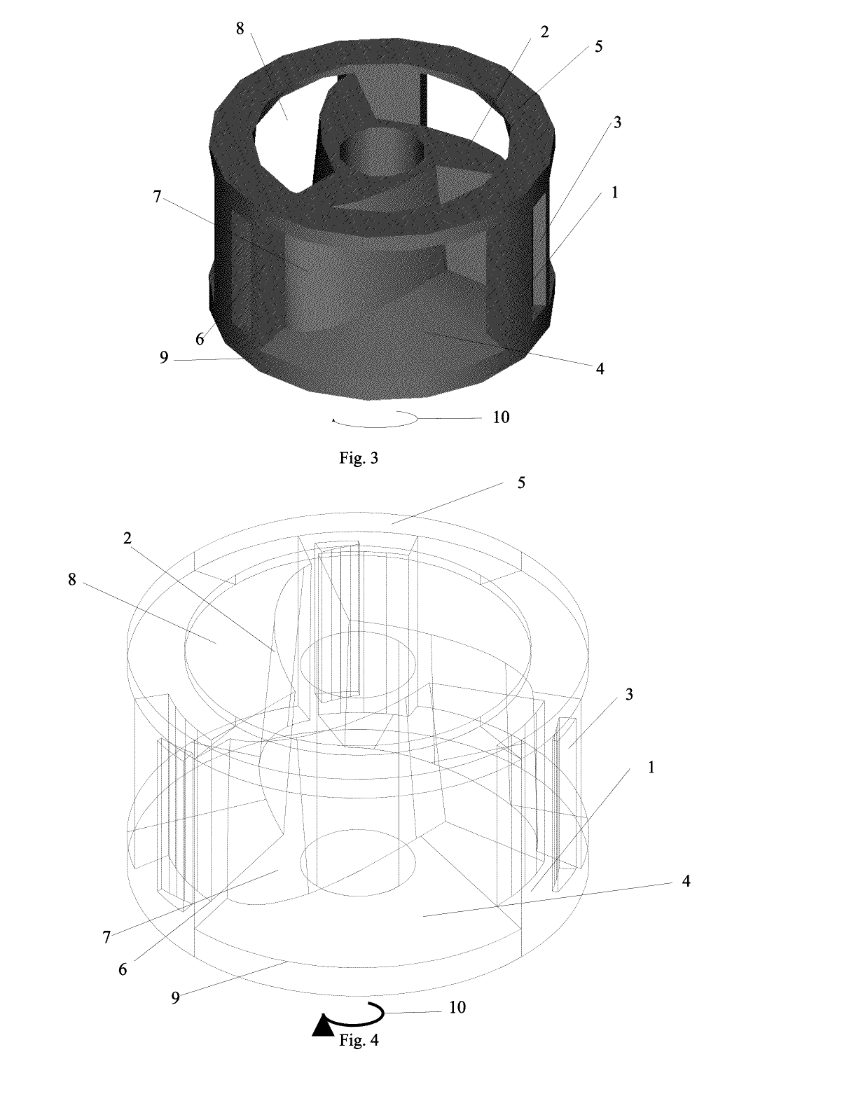

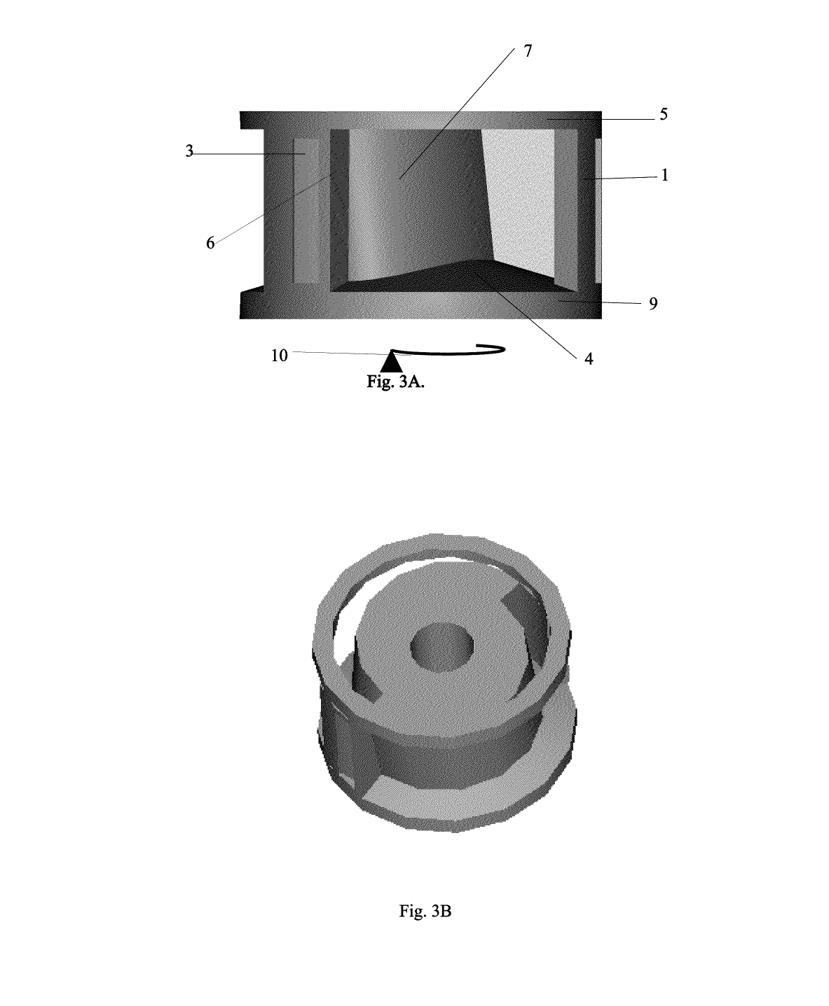

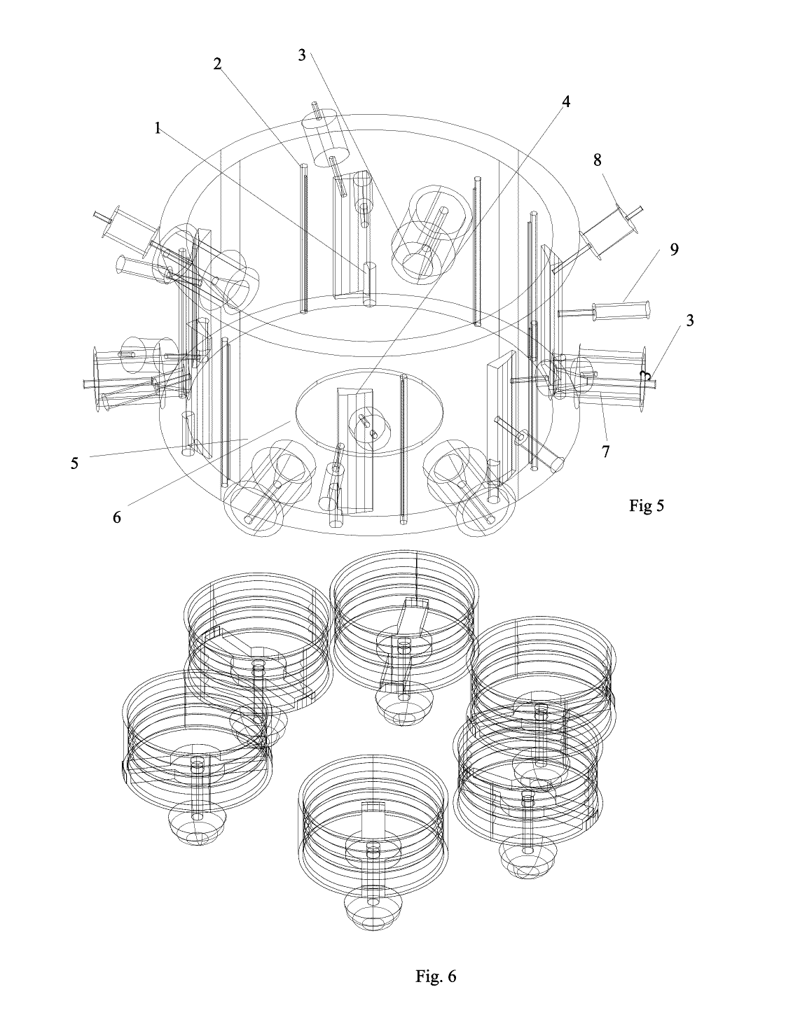

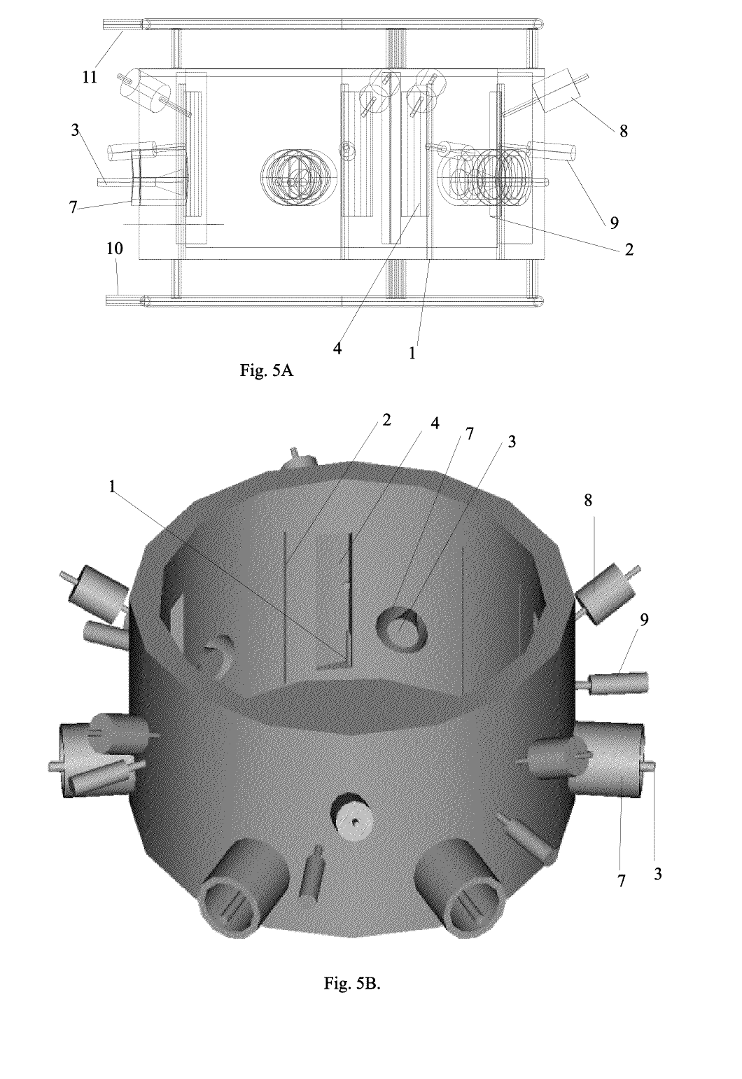

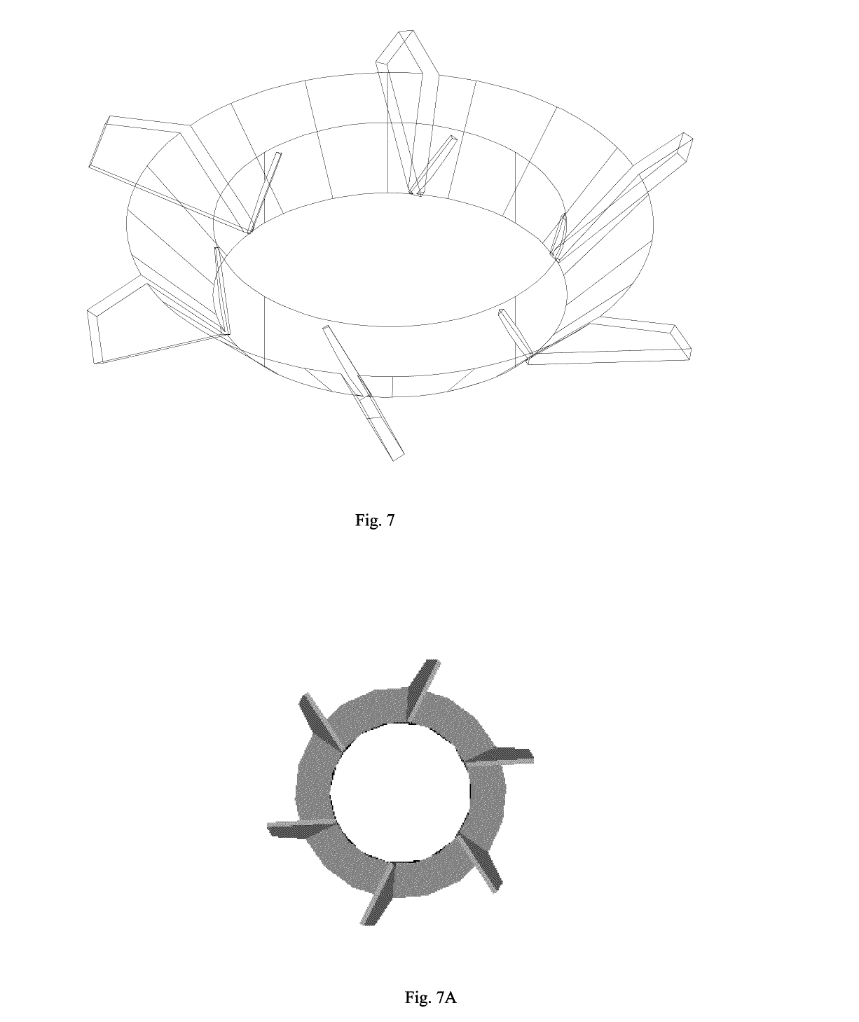

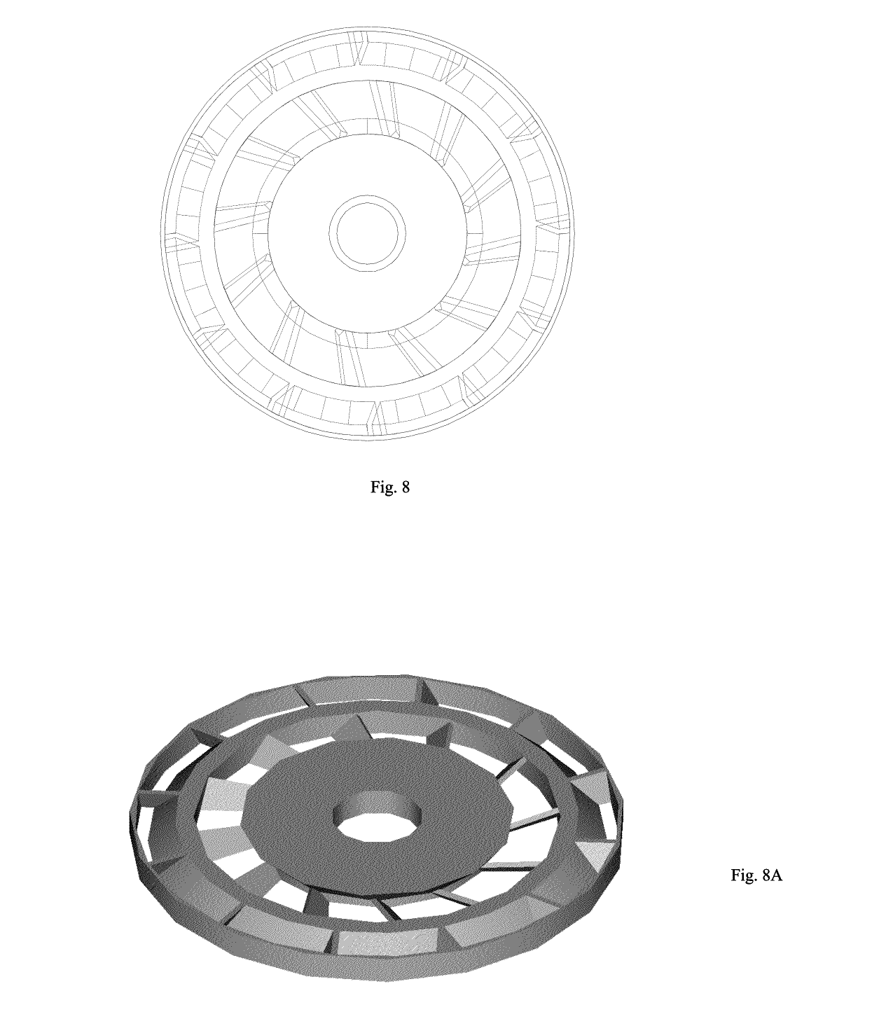

FIG. 3A is view of a molded TRE-rotor from laterally.

FIG. 3B is view of a molded TRE-rotor from laterally with only two R-pallets.

FIG. 5 is a schematic front-up view of TRE-stator with six groups of intake air conducts, S-chambers and M-seals.

FIG. 6 is a schematic front-up view of over compression cylinders and pistons.

FIG. 5A is a schematic front-up view of TRE-stator with M-seal intake and return attached.

FIG. 5B is a view of a molded TRE-stator.

FIG. 7 is a schematic drawing of flux coordinator.

FIG. 7A is a view of molded flux coordinator.

FIG. 8 is a schematic drawing of turbocharger and-or fan compressor.

FIG. 8A is a view of molded turbocharger and-or fan compressor.

FIG. 9 is a transversal section from a molded engine presenting the dynamic flux way,

### DETAILED DESCRIPTION OF THE INVENTION

The basically concepts of this engine is to create a quasi-static thermodynamic parametric resonant loop what to consume energy changing it's parametric states against external absorption processes. The thermodynamic loop is realized via thermodynamic gas flux starting from the burning chambers which are creating in explosive burning processes a thermal flux and dynamic presser-flux. A big part of energy thermo-flux is preloaded from it, for every components of engines, in is way to exhaust exit and the different loosed in the atmosphere then the turbo charger is saving a big parts of it absorbing a big volume a pure gas and pushing it in intake manifold cooling the part of exhaust system and engine parts. The same gas flux but with is dynamic components will be losing positively for our process a principal amount of energy in four distinctive fazes in it's way (burning chambers-exhaust exit), first faze the explosion fazes will transform a important amount of this energy in energy mechanic of revolving the rotor around of it's rotating axle, the inside rotor geometry will be mirroring the flux inside-back splitting it's transversal to the shaft,(dynamic components) in two components, transversal and longitudinal inside back, now the flux coordinator will take a amount of this energy helping the rotor in it's process of revolving, a big amount of the remained dynamic components will actuate the turbo charger. The turbo charger will act now like a loop reversing component taking from outside via intake manifold a big amount in volume of pure air, preferably the same volume of exhaustive gas or 2-4 times more, imprinting it with a amount of dynamic presser and driving it between intake manifold and exterior wall of engine cooling the engine and then tacking off a amount of thermal energy, a amount of this energy will increase the presser of the pure gas and then it's dynamic pressure in it's way to the stator interior where will meet the remained exhaustive flux what is relatively moving from up to the shaft axe and interior and then will be forming a superficial flux of pure air at the level of stator surface, air needed for next burning faze. At this level is needed a very carefully constructive dimensional geometry (volumetric-polar-surfaces-axis) what to answer positively for maintaining the thermodynamic resonant process.

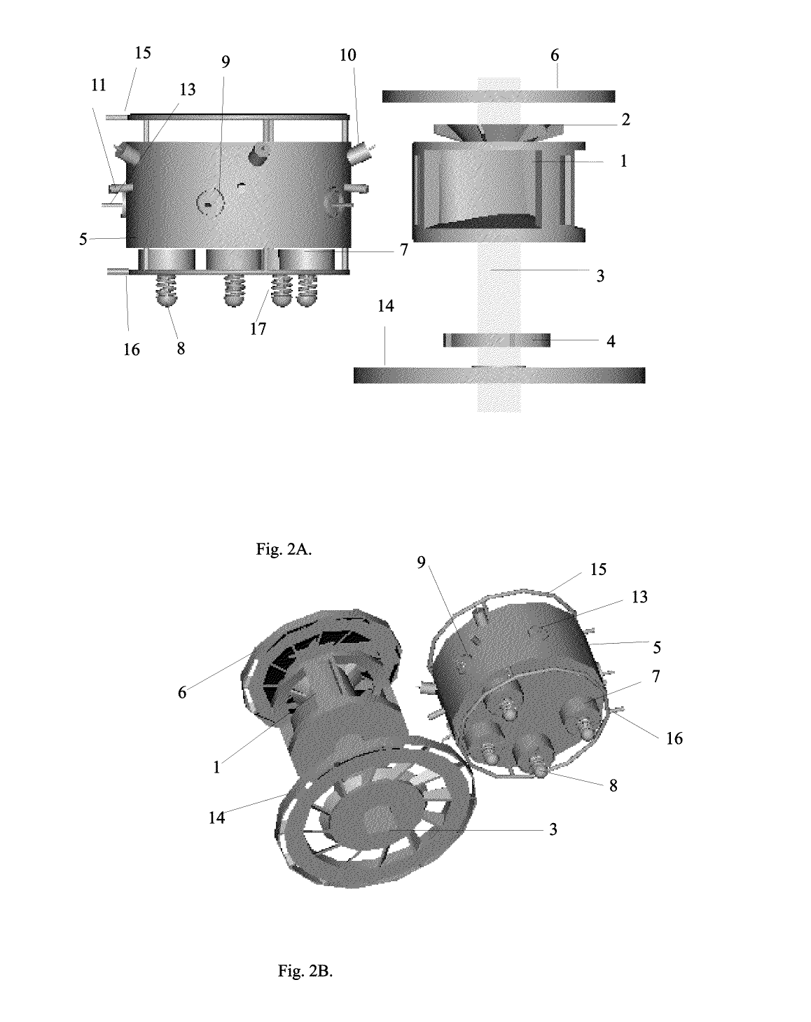

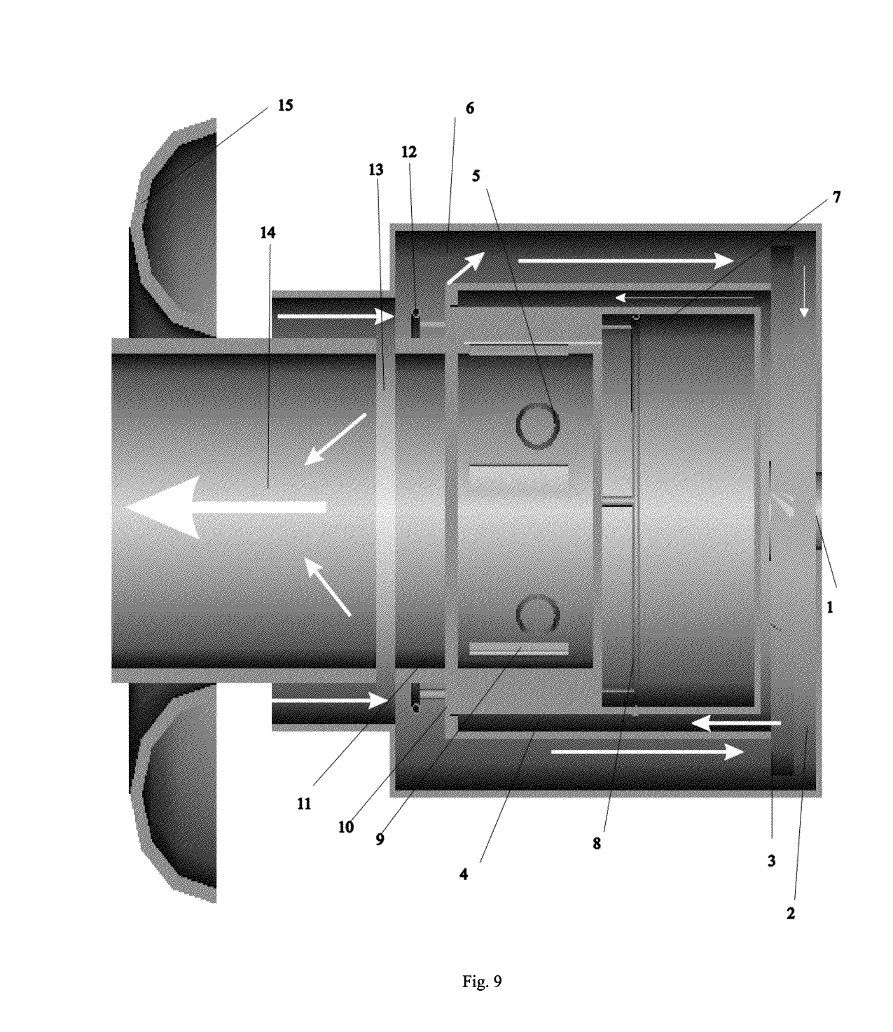

For this engine to be functional it's rapport dimensional must to respect any rules like distribution of S-chambers splits FIG. 2 (12) must to have a non symmetric polar distribution on stator FIG. 2(5) and the interior surface oriented contrary of revolving sense and angular, every air conduct FIG. 2(9) coming from the intake to be inserted maxim frontal relatively of every S- cambers split and back of it relatively to revolving sense, the injectors FIG. 2 (11) central on S-chambers split, the sparks FIG. 2(10) near of it, the rotor the principal element of the engine must to have a special shape like in FIG. 3 and intimately connected to the shaft FIG. 2(3) with R-pallet FIG. 3(1)-FIG. 4(1), R-reflector FIG. 3(2)-FIG. 4(2), cylinder wall protector FIG. 3(4)-FIG. 4(4) and after shock balance FIG. 3(1)-FIG. 4(1). The stator FIG. 5 must have it's interior diameter very near—a fractions of millimeters up—from rotor diameter, the S-chambers split FIG. 5(4) to be mirroring R-chamber split when meet it in revolving process, the M-seals FIG. 5(2) to be in the front of every S-chambers split relatively to revolving sense, tubular intakes, FIG. 5(7), with flux deflectors, FIG. 5(3) after S-chambers splits relatively to revolving sense and very near longitudinal from position of RTE-rotor wall protector and it's front cylindrical wall house to have inserted correspondent tubular feeders for M-seals and correspondent to S-chambers seals tubular communications holes to over compression cylinder pistons. The distribution of these components must to be polar eccentric.

The over-compression cylinders and over-compression pistons (FIG. 6 and FIG. 6A}, will be on the front of front S-stator wall house and correspondent to tubular over compression communicators FIG. 6 with piston rod doing common corps with piston and together having only a front-back moving with a small step. Then the cylinder-piston must to have a big diameter, in the front-moving piston will be a answer at a cam action what is directed of a synchronizer, the back return will be assured of a spring spiral. The TRE-flux coordinator FIG. 7 must to do common corpse with TRE-rotor and the shaft for a good gradient of thermal flux. The turbo fan compressor will be dependent of shaft and turbo charger FIG. 8 will be independent of shaft.

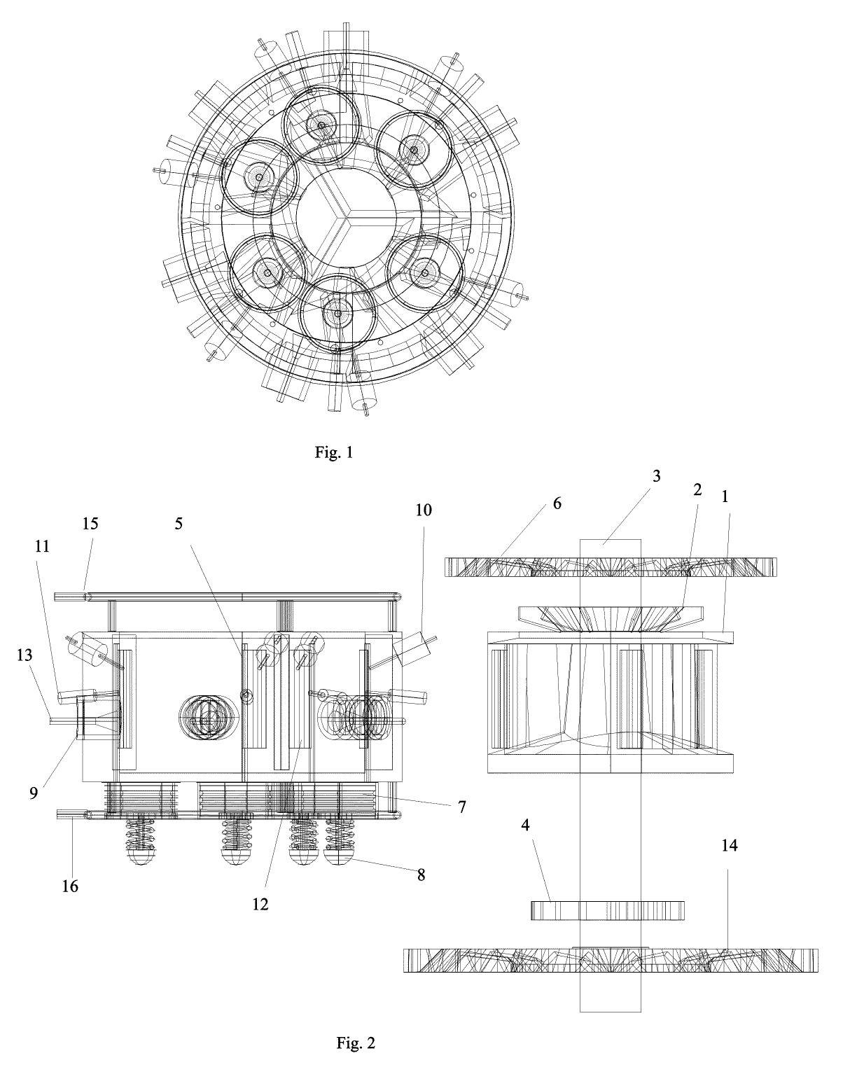

The principal point of this invention is RTE-rotor with is a 3-Dimensional distribution what separate the old cylinder chamber in two important components and in the same time to be a flux distributor component. First component is practically on stator(S-chamber) the rotor with is R-pallet (FIG. 3-1) isolating (sealing) it at the compression-ignition-explosion timing. The R-chamber (FIG. 3-3) isn't playing a big role at this time, in any embodiments it can to be lose and then the compression-ignition chamber calibrated in a adequate volume on stator, but, the R-chamber can to play a important role as a “magic cup”, accumulating fuel from the M-seal and reading it for next detonation.

The second component is detention chamber what can be defined as the space between back R-pallet wall (FIG. 3-6) (with a principal role in revolving process), front and back after shock balance's (FIG. 3-5 and 9) and R-reflector (FIG. 3-7 and 2). In FIG. 4 those are noted with the same numbers. The flux distributor components are the geometrically forms for those components like the conics for front and back after shock balancers what to drive the flux back inside. The sense of rotation for rotor is see in (FIG. 3-10)

The M-seal is a prismatic capillary with is opened faces to the cylinder to wet the R-pallet and partially front and back after shock balances and it's wide dimension in a order of the capillary diameter of fluid seal at milliseconds drops (around of a millimeters) depend of what kind of fluid seal will use.

The fluid seal will define a capillary surface between R-pallet and stator and the capillary pressure will seal totally the compression-ignition-explosion chamber but will not oppose a resistant force for the drift. The best fluid seal can to be the fuel with any additive for fluid fuel or a low octane fuel, for gas fuel a low octane fuel. For it the exterior diameter of rotor is low relatively of interior diameter of stator, millimeters, and then the diameter of shaft must to be relatively big to amortize transversal vibrations instantly.

The conduct what is driving the fluid seal to the M-seals will be connected to a low-medium pressure fluid pump. The fluid seal vapor result will be burned back of rotor with a positively infusion in efficiency.

The rotor, stator and shaft must to be build from the same material with the exactly the same coefficient of dilatation to present the same thermo gradient.

The numbers of R-pallets and R-reflectors on rotor is a function of rotor diameter, of RPM needed, the numbers of groups of air canal, S-cambers and M-seals on stator and is dictated first of the necessity to conduct the expansion flux out of rotor between two detention timing for the same R-pallet.

The configuration of rotor is coming with a new useful parametric constituent what is the delay between ignition and expansion what mean the explosive burning process will have a time of adiabatic evolution with a increasing possibility of complete burning (if the oxygen will be enough) at a relatively low compression rate.

This engine with is variant with a double way fan air compressor fixed to shaft or connected to shaft via a gear multiplication will need the cylinder-piston compressor only to reach the auto resonant dynamic flux regime work, after that the pistons compression can to be blocked in closed position.

Resonant with rotor rotation and detention inside of stator the flux will present a pulse play, quasi-static resonant with burning processes between dynamic pressure and static pressure defining the quasi static pressure as a equilibrium pressure in this play and not the external static pressure. The rotor will work efficiently when the dynamic pressure of air coming via tubular intake holes guarded with accidentally flux deflectors will be near of this quasi static pressure. This engine is a encapsulate engine and in FIG. 9 can see the way of dynamic flux.

The auto resonant dynamic flux regime work is build and assured from the air double way fan compressor and turbofan (turbocharger). The double way turbocharger can to be a classic one adapted to work for a encapsulate intake-exhaust system if the double way turbocharger in it's presented form will not resist at different thermo gradient between up and down.

Accepting a hard start, in a variant this engine can to no had the cylinders and pistons compression and to be the best air supplier for a jet engine increasing it's efficiency.

The base of this engine is the rotor and the engine can to have a lot of variants wearing this rotor or appropriate forms like one described in FIG. 3D and FIG. 3E with only 2 pallets what can to be the best for a lot of variants because present a long way for exhaust flux refuge.

The symmetry near of perfectly(only the eccentric distribution for S-chambers around of 15 polar gr. between first and the last), not valve, not supplementary mechanisms(the over compression pistons and cam system can to be blocked after reaching is regime of dynamic compression) can to make this engine a universal engine if technologically can to be build and if will prove is efficiency.

### DETAILED DESCRIPTION OF THE DRAWINGS

FIG. 1A emblematic front representation for TRE-engine what mean a thermodynamic resonant engine or totally rotary engine.

FIG. 2, FIG. 2A and FIG. 2B are about a relative configuration and positions of components of engine, 1. TRE-rotor, 2-flux coordinator, 3-the shaft, 4-sincroniser, 5-stator, 6-double-way turbo charger, 7-over compression cylinder, 8-over compression pistons rod, 9-dynamic flux air communicator, 10-injector, 11-spark, 12- S-chamber, 13-accidentally flux deflector, 14-double way turbo fan compressor, 15-the fluid seal feeder conduct return, 16-the fluid seal feeder conduct intake, 17-the return over compression piston spring.

FIG. 3, FIG. 4 and FIG. 3A present the design for TRE-rotor with 3 pallets in configuration with: 1-R-pallet, 2-R-reflector, 3-R-chamber split, 4- interior surfaces of cylinder wall protector (front after shock balancer), 5-back after shock balancer, 6-back wall pallet what is a important transformer of expansion burning flux energy in mechanic energy of rotation, 7-principal faces of R-reflector with positive rapport in process, 8-a apparently view of expansion chamber, 9-cylinder wall protector (front after shock balancer), 10-the sense of rotation for rotor.

FIG. 3B. present only a design for TRE-rotor what can to be more efficiently for any variant of engine because the polar distribution for expansion chambers can assure more timing for expansion flux refuge.

FIG. 5, FIG. 5A and FIG. 5B is trying to present the TRE-stator in it's complexity, 1-the canal communicator between over-pressure cylinder-piston and S-chamber split, 2-the M-seal with it's prismatic capillary and canal feeder, 3-accidentally flux deflector, 4-S-chamber split, 5-front wall TRE-stator, 6-shaft passage, 7-intake air communicator, 8-injector, 9-spark plug, 10-fluid seal return conducts, 11-fluid seal intake conducts.

FIG. 6. present the over-pressure cylinders and pistons configuration for a TRE-stator with 6 S- chambers split.

FIG. 7, FIG. 7A are a drawing and molded image for TRE-flux coordinator.

FIG. 8, FIG. 8A are a drawing and molded image for fan air compressor and turbocharger what conceptually are the same presenting only deferent mechanism of connection and deferent numbers of blades and dimensional.

FIG. 9 is a transversal section from a molded engine presenting the dynamic flux way, with: 1-the shaft passage, 2-dynamic flux pressure equalizer spaces, 3-double way turbo fan compressor, 4-the way of dynamic flux to the air communicators of stator, 5-the intake flux communicator guarded of accidentally flux deflector, 6-dynamic flux pressure equalizer spaces, 7-the house of synchronizer, over compression system, and cam system, 8-the conduct of seal fluid feeder return, 9-S-chamber split, 10-stator, 11-the house of TRE-flux coordinator, 12-the conduct of seal fluid feeder intake, 13-turbocharger, 14-the exhaust escape tube, 15-the air reflector.

1. A engine with a special new components, geometrical (dimensions and positions of electro mechanic components) configured to assure a thermodynamic resonant loop with a dynamic parametric state said M Thermodynamic resonant engine, comprising:
a TRE-rotor, a TRE-stator, a flux coordinator, a turbo fan compressor, a turbocharger and a front wall cylinder comprising or having attached next components: imprinted holes exactly correspondent and the same radius for M-seals and pistons communicators, a hole centered for shaft passing, the over compression pistons and their cylinders, over compression piston must to have only a free grade of movement (back-front) and a small step(maybe not more of 1 cm.) and the communication port to have a small diameter and in the same time at compression point to intimately rich the front wall to avoid the impact force of explosion and a cam shaft system answering at a synchronizer actions what is fixed on driven shaft.

2. A engine with a rotor said TRE-rotor, as claimed in claim 1 cu a special shape (and appropriate forms) without eccentrics revolving components, what is format from a cylindrical forming(initial form) structure having, 1, 2, 3 or 4 parts symmetric and polar equal distributed on-in cylindrical forming structure and every one with 2 different structural parts and different role: first one a cylindrical pallet said R-pallet calotte having imprinted a R-chamber split (in any embodiments can be without R-chamber split)with is radius of revolution in a angle relative to radius of forming cylinder different of zero and second one posted at a step down and with elliptical face and inclined to interior said R-reflector with two assignments (to convert a part of dynamic pressure from after shook flux and to reflect it to the after burning way via flux coordinator and if technologically possible doing common corpse with shaft and flux coordinator for a uniform gradient of thermo flux in material, guarded in the front for a full shaped cylinder said cylinder wall protector (front after shock balance) with the same exterior diameter of cylindrical pallets calottes and in the back a tube cylinder said back after shock balance with the same exterior diameter and with interior diameter a fraction down of elliptical face- all elements from same material and intimately connected.

3. A special shaped structure disposed on power output shaft of tree or six pallets inclined in two directions, down and back, said flux coordinator as claimed in claim 1 with two assigned roles, taking over of a remained revolving components from after burning dynamic flux and to ordinate the after burning flux.

4. A tubular (triangular or hexagonal or octal) shaped cylinder said TRE-stator as claimed in claim 1, comprising or having attached next components: a imprinted (3, 6 or 8) mirroring of R-chamber split said S-chamber split with a eccentric polar distribution, (4,7 or 9) longitudinal capillary seal said M-seal with a feeder cylindrical hole said M-seal feeder, 3,6 or 8 injectors and sparks communicating with superior face of S-cambers, 3,6 or 8 cylindrical transversal inserted holes to assure the communication between S-chambers and over compression pistons and 3,6,8 tubular intakes with strongly fixed flux deflectors and communicating outside with intake manifold -only and only-, intake manifold, what is covering the engine and strongly sealed to it to assure the dynamic pressure of inner flux at a level created of turbo charger and to be cooling the engine.

5. A totally rotary engine and pulse turbine with a configuration for RTE-rotor what separate the compression-ignition-expansion chamber in compression-ignition chamber and a expansion chamber with a temporarily delay between ignition and expansion what in any variants can had supplementary conducts coming from the intake manifold inserted in over-compression cylinders and without or with air conducts inserted in stator.

6. A capillary seal said M-seal what to exclude the direct metallic friction and then metallic ions components residual in water vapors.
